(19) United States
(12) Patent Application Publication
(10) Pub. No.: US 2014/0172281 A1
(43) Pub. Date: Jun. 19, 2014

(54) ECU DATA SETTING SYSTEM AND METHOD EMPLOYING EOBD SELECTION LOGIC

(71) Applicant: Hyundai Motor Company, Seoul (KR)

(72) Inventors: Sang Il Yoon, Anyang-si (KR); Su Young Park, Uiwang-si (KR); Tae Young Kim, Gunpo-si (KR)

(73) Assignee: Hyundai Motor Company, Seoul (KR)

(21) Appl. No.: 13/904,844

(22) Filed: May 29, 2013

(30) Foreign Application Priority Data
Dec. 18, 2012 (KR) 10-2012-0148059

(51) Int. Cl. F02D 28/00

(52) U.S. Cl. CPC F02D 28/00
USPC 701/115

(57) ABSTRACT

An engine control unit (ECU) data setting system employs an European on-board diagnosis (EOBD) selection logic by which a function of managing and operating data according to application of EOBD can be improved, and an ECU data setting method. The ECU data setting system employing an EOBD selection logic includes: a control logic including a software switch for selecting application of EOBD; and end of line (EOL) equipment operated by the software switch of the control logic to input a control signal to an ECU and set application of the EOBD.

### CROSS-REFERENCE TO RELATED APPLICATION

The present application claims priority of Korean Patent Application Number 10-2012-0148059 filed Dec. 18, 2012, the entire contents of which application is incorporated herein for all purposes by this reference.

### BACKGROUND OF INVENTION

1. Field of Invention

The present invention relates to an engine control unit (ECU) setting system, and more particularly to an ECU data setting system employing a European on-board diagnosis (EOBD) selection logic by which the function of managing and operating data according to application of EOBD can be improved, and an ECU data setting method thereof.

2. Description of Related Art

In recent years, as devices of vehicles are electronized, an engine control unit (ECU), among electronic control devices, for controlling an amount of suction air and an ignition timing of an engine to optimize an output of the engine and minimize an amount of exhaust gas is being emphasized.

The engine control unit is operated by operation software and mapping data stored in an embedded memory, and constituent elements of the operation software and mapping data depend on a type and an option of the vehicle

Meanwhile, an on-board diagnosis (OBD) system refers to an apparatus which, when a problem occurs in a vehicle, turns on a malfunction indication lamp (MIL) on a dashboard to inform a driver of an abnormal state, and also called as an operation record (or exhaust gas) self-diagnosing apparatus. In Korea, the OBD system has been compulsorily mounted to all cars sold in Korea since 2005.

European on-board diagnosis (EOBD) refers to a self-diagnosing method provided by European Union, and its application of currently mass-produced vehicles corresponding to Euro 4 or Euro 5 Rule depends on local areas. Thus, according to ECU, different contents should be applied at local areas to which the rule is applied.

Accordingly, the number of operated data unnecessarily increases, in which case in spite that data about performance and output are the same, a large amount of data in which only flickering of an MIL lamp related to EOBD or elements related to restriction on output in relation to exhaust gas exist, often causing confusion of work in end of lines (EOLs) of mass-produced vehicles.

FIG. 1 is a table depicting data of an ECU according to application of EOBD.

The items in the drawing correspond to items by which various data are managed according to application of EOBD when the standard of Euro 4 is applied to a single engine option. In detail, if data a1, b1, c1, and d1 exist when EOBD is applied to four vehicle models, four different data 12, b2, c2, and d2 exist even when EOBD is not applied. As a result, eight data are managed.

That is, even in the case of the same model and the same output, applied data becomes different according to application of EOBD, making work in the EOL complex.

The information disclosed in this Background section is only for enhancement of understanding of the general background of the invention and should not be taken as an acknowledgement or any form of suggestion that this information forms the prior art already known to a person skilled in the art.

### BRIEF SUMMARY

The present invention provides an engine control unit (ECU) data setting system which can conveniently select application of European on-board diagnosis (EOBD) in a production end of line (EOL) to apply an EOBD selection logic by which a function of operating and managing ECU data can be improved, and an ECU data setting method.

In accordance with an aspect of the present invention, there is provided an ECU data setting system employing an EOBD selection logic, including: a control logic including a software switch for selecting application of EOBD; and EOL equipment operated by the software switch of the control logic to input a control signal to an ECU and set application of the EOBD.

In various aspects of the present invention, the EOL equipment may be connected to the ECU through a CAN communication to set application of the EOBD.

In various aspects of the present invention, the software switch may select one of two parameters of application and non-application of the EOBD.

In various aspects of the present invention, the software switch may set a parameter value for application of the EOBD with an error of selection of application or non-application of the EOBD or a default value in the case of nothing being input.

In various aspects of the present invention, there is provided An ECU data setting method through which the ECU data setting system employing an EOBD selection logic is operated, the ECU data setting method including: downloading and storing data in the ECU; determining a selection parameter of the EOBD with the software switch of the control logic; and setting application or non-application of the EOBD to the ECU with the EOL equipment according to selection of the software switch.

In various aspects of the present invention, the selection parameter may have two parameter values according to application or non-application of the EOBD, and may set a value corresponding to the application of the EOBD as a default value to cope with a non-input of selection or an error.

Thus, different operation data are used even in the case of the same engine, model, and output according to application of EOBD according to the related art, whereas according to the ECU system setting system and method employing an EOBD selection logic according to the present invention, the number of data can be prevented from increasing, thereby minimizing an amount of managed data, that is, single ECU data can be generally used areas to which EOBD is applied or not through setting of an EOL equipment. Thus, the function of operating and managing the ECU data can be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a table depicting data of an engine control unit (ECU) according to application of European on-board diagnosis (EOBD);

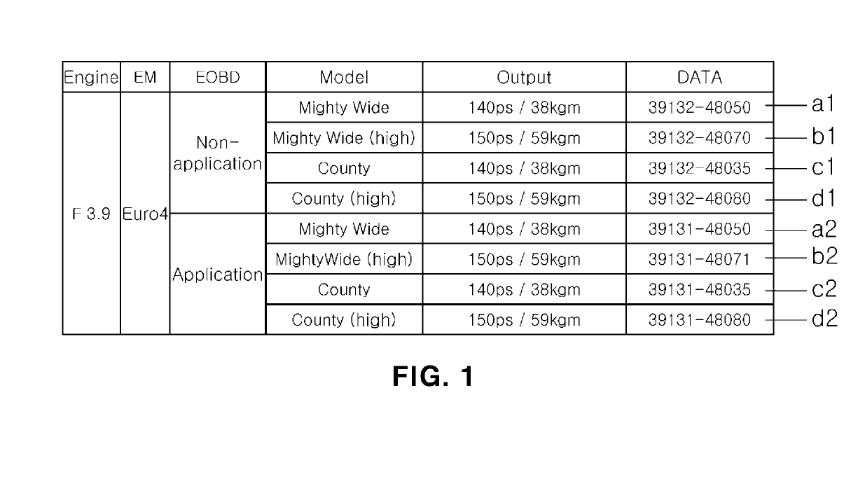

FIG. 2 is a concept view of an exemplary ECU data setting system employing an EOBD selection logic according to the concept of the present invention;

FIG. 3 is a table depicting parameters applied in end of line (EOL) equipment of an exemplary ECU data setting system employing an EOBD selection logic according to the present invention; and

FIG. 4 is a system diagram showing a control logic of an exemplary ECU data setting system employing an EOBL selection logic according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, engine control unit (ECU) data setting system and method employing a European on-board diagnosis (EOBD) selection logic according to the present invention will be described in more detail with reference to the accompanying drawings.

The concept of the present invention is basically followed by a process of inputting and setting data of an ECU, and data of an ECU related to EOBD include breakdown diagnosis control of EOBD, setting of a breakdown environment related to EOBD, control of a malfunction indication (MIL) lamp, and control items related to restriction of output. However, it is noted that the types or titles of data are exemplary but other data can be added or the titles of the data can be changed.

Further, it is understood that in the description of the present invention, although EOBD corresponding to a concept of self-diagnosis of European Union, OBD of another type is not excluded but fall within the scope of the present invention.

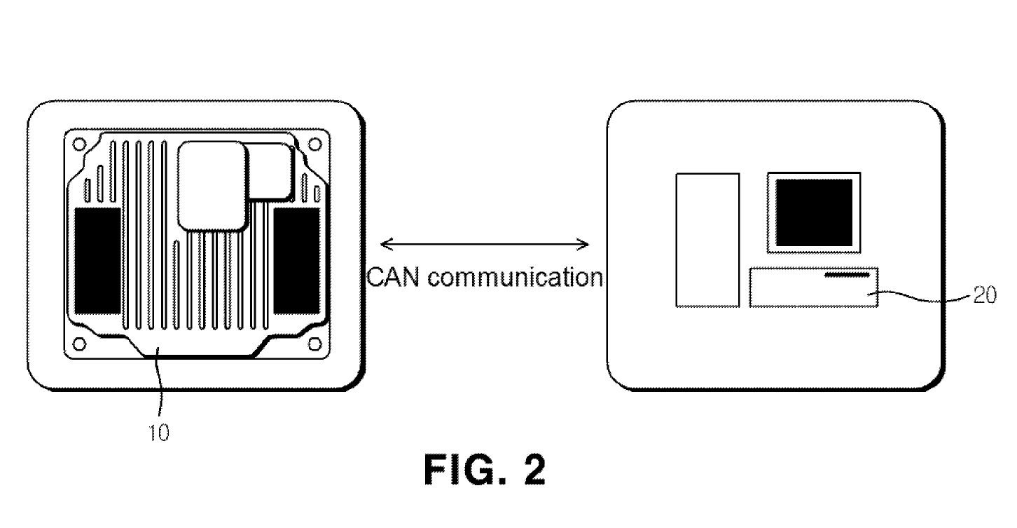

FIG. 2 is a concept view of an ECU data setting system employing an EOBD selection logic according to the concept of the present invention.

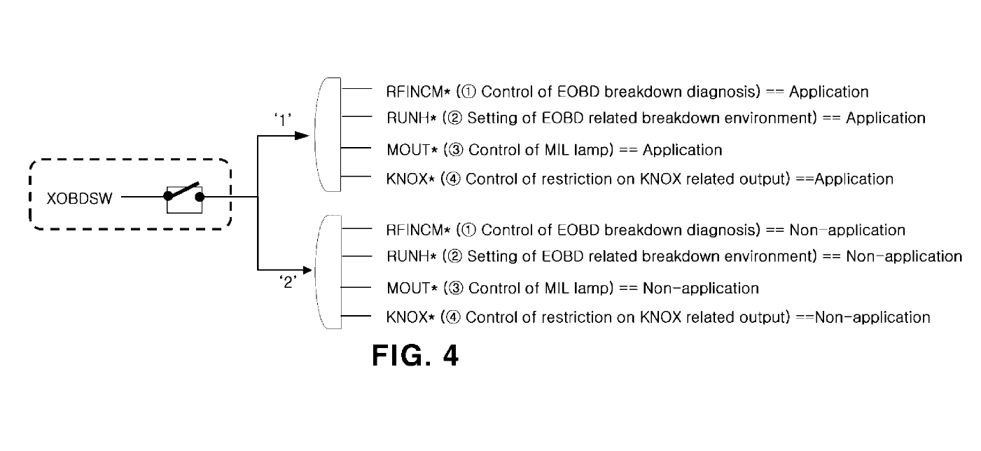

The ECU data setting system according to the present invention includes a control logic provided with a software switch (21 of FIG. 4) for selecting application of EOBD, and end of line (EOL) equipment operated by the software switch 21 of the control logic and through which a control signal is input to an ECU 10.

As will be described below, the EOL equipment 20 allows the ECU 10 to determine application of software related to EOBD by using a predetermined parameter through the control logic, and the control logic may be mounted to the EOL equipment 20 in a software fashion or may be switched though selection of an operator.

The ECU 10 sets application of EOBD through the EOL equipment 20 in a predetermined process, and in detail, after overall data of the vehicle related to control of an engine and a gear are downloaded, application of EOBD can be selected through the EOL equipment 20 connected to a predetermined control line.

The ECU 10 may be connected to a control line of the EOL equipment 20 in various ways, and for example, may be mechanically connected through a point to point method, but a multi-master communication method is suitable in terms of efficiency. According to the concept, application of EOBD between the ECU 10 and the EOL equipment may be determined through CAN communication.

A controller area network (CAN) communication is mainly used for a network for a vehicle, and can identify transmission messages of all device on a network, can determine whether the messages is to be filtered, and is strong to noise. Thus, setting of EOBD after data of the ECU 10 are completely downloaded may be performed through the CAN communication.

The software switch 21 may be included in the control logic, or environment setting such as control of an MIL lamp or control of restriction of output may be simply selected.

It is noted that since application of EOBD of data in a production EOL may be set according to the ECU data setting system employing an EOBD selection logic according to the concept of the present invention, the ECU data can be unified.

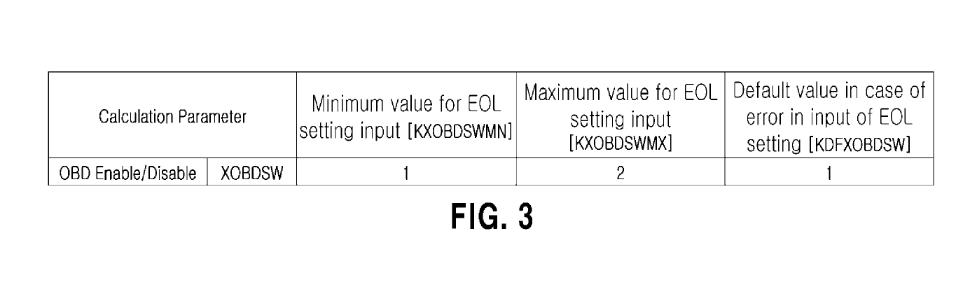

FIG. 3 is a table depicting parameters applied in EOL equipment of the ECU data setting system employing an EOBD selection logic according to the present invention.

XOBDSW in the drawing shows the software switch 21, and it has already been described that the software switch 21 can select application of EOBD.

Here, since two selection modes of application and non-application exist, a minimum input value in the EOL is set to 1 and a maximum value is set to 2.

The minimum set value 1 may mean application of EOBD, and the maximum set value 2 mean non-application of EOBD.

Thus, the selection parameter selected by the software switch 21 may be set to 1 or 2 so that the EOL equipment 20 can set application of the EOBD to the ECU 10.

Additionally, when selection is not made by the software switch 21 or an input error is generated, a need to set a default value exists, in which case the selection parameter may be set to 1 as a default value.

However, the values of the selection parameters are examples and the present invention is not limited thereto. Further, it is noted that it is not excluded that the default value is set to 2 in some cases.

FIG. 4 is a system diagram showing a control logic of the ECU data setting system employing an EOBL selection logic according to the present invention.

As described above, the control logic includes the software switch 21, the selection parameter may be 1 or 2 according to an operation of the software switch 21, and the EOL equipment 20 may set data corresponding to application or non-application of EOBD, respectively.

As shown in the drawing, when the selection parameter 1 is set through selection of the software switch 21, the ECU data setting system employing an EOBD selection logic of the present invention connected to the ECU 10 through a CAN communication may be set such that EOBD breakdown diagnosis control, EOBD related breakdown environment setting, MIL lamp control, and NOX related output restriction control may be applied to the ECU 10.

Likewise, when the selection parameter 2 is set through selection of the software switch 21, the ECU data setting system employing an EOBD selection logic of the present invention connected to the ECU 10 through a CAN communication may be set such that EOBD breakdown diagnosis control, EOBD related breakdown environment setting, MIL lamp control, and NOX related output restriction control may not be applied to the ECU 10.

A method of realizing of the ECU data setting system employing an EOBD selection logic according to the concept of the present invention may include a step of downloading and storing data in the ECU 10, a step of determining a selection parameter of the EOBD with the software switch 21 of the control logic, and a step of setting application or non-application of the EOBD to the ECU with the EOL equipment 20 according to selection of the software switch 21. Here, the repeated description will be omitted.

In this case, the selection parameter has two parameter values according to application or non-application of the EOBD, and a value applied as a default value may be set to cope with non-input or an error.

Thus, different operation data are used even in the case of the same engine, model, and output according to application of EOBD according to the related art, whereas according to the ECU system setting system and method employing an EOBD selection logic according to the present invention, the number of data can be prevented from increasing, thereby minimizing an amount of managed data, that is, single ECU data can be generally used areas to which EOBD is applied or not through setting of an EOL equipment. Thus, the function of operating and managing the ECU data can be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine control unit (ECU) data setting system employing an European on-board diagnosis (EOBD) selection logic, comprising:
a control logic including a software switch for selecting application of EOBD; and
end of line (EOL) equipment operated by the software switch of the control logic to input a control signal to an ECU and set application of the EOBD.

2. The ECU data setting system of claim 1, wherein the EOL equipment is connected to the ECU through a CAN communication to set application of the EOBD.

3. The ECU data setting system of claim 1, wherein the software switch selects one of two parameters of application and non-application of the EOBD.

4. The ECU data setting system of claim 3, wherein the software switch sets a parameter value for application of the EOBD with an error of selection of application or non-application of the EOBD or a default value in the case of nothing being input.

5. An ECU data setting method through which the ECU data setting system employing an EOBD selection logic of claim 1 is operated, the ECU data setting method comprising:
downloading and storing data in the ECU;
determining a selection parameter of the EOBD with the software switch of the control logic; and
setting application or non-application of the EOBD to the ECU with the EOL equipment according to selection of the software switch.

6. The ECU data setting method of claim 5, wherein the selection parameter has two parameter values according to application or non-application of the EOBD, and sets a value corresponding to the application of the EOBD as a default value to cope with a non-input of selection or an error.

7. An ECU data setting method through which the ECU data setting system employing an EOBD selection logic of claim 2 is operated, the ECU data setting method comprising:
downloading and storing data in the ECU;
determining a selection parameter of the EOBD with the software switch of the control logic; and
setting application or non-application of the EOBD to the ECU with the EOL equipment according to selection of the software switch.

8. The ECU data setting method of claim 7, wherein the selection parameter has two parameter values according to application or non-application of the EOBD, and sets a value corresponding to the application of the EOBD as a default value to cope with a non-input of selection or an error.

9. An ECU data setting method through which the ECU data setting system employing an EOBD selection logic of claim 3 is operated, the ECU data setting method comprising:
downloading and storing data in the ECU;
determining a selection parameter of the EOBD with the software switch of the control logic; and
setting application or non-application of the EOBD to the ECU with the EOL equipment according to selection of the software switch.

10. The ECU data setting method of claim 9, wherein the selection parameter has two parameter values according to application or non-application of the EOBD, and sets a value corresponding to the application of the EOBD as a default value to cope with a non-input of selection or an error.

11. An ECU data setting method through which the ECU data setting system employing an EOBD selection logic of claim 4 is operated, the ECU data setting method comprising:
downloading and storing data in the ECU;
determining a selection parameter of the EOBD with the software switch of the control logic; and
setting application or non-application of the EOBD to the ECU with the EOL equipment according to selection of the software switch.

12. The ECU data setting method of claim 11, wherein the selection parameter has two parameter values according to application or non-application of the EOBD, and sets a value corresponding to the application of the EOBD as a default value to cope with a non-input of selection or an error.
